(19) United States
(12) Patent Application Publication
(10) Pub. No.: US 2015/0371375 A1
(43) Pub. Date: Dec. 24, 2015

(54) MERCHANDISE IDENTIFICATION APPARATUS, METHOD OF RECOGNIZING DISCOUNT OF MERCHANDISE, AND FRESHNESS DEGREE LABEL

(71) Applicants: KABUSHIKI KAISHA TOSHIBA, Tokyo (JP); TOSHIBA TEC KABUSHIKI KAISHA, Tokyo (JP)

(72) Inventor: Sunao TABATA, Shimizu Shizuoka (JP)

(21) Appl. No.: 14/313,304

(22) Filed: Jun. 24, 2014

(51) Int. Cl. G06T 7/00; G06Q 30/02; G06Q 20/20; G06T 7/40

(52) U.S. Cl. CPC G06T 7/0004; G06T 7/408; G06T 7/0081; G06Q 30/0238; G06Q 20/201; G06T 2207/30128

(57) ABSTRACT

A merchandise identification apparatus includes an image acquisition unit, a first extraction unit, a second extraction unit, and a determination unit. The image acquisition unit acquires a merchandise image of a merchandise to be purchased. The first extraction unit extracts an image of a freshness degree label from the merchandise image acquired by the image acquisition unit. The second extraction unit extracts image information indicating a degree of freshness of the merchandise from the image of the freshness degree label extracted by the first extraction unit. The determination unit determines a discount to a purchase price of the merchandise according to the image information indicating the degree of freshness of the merchandise extracted by the second extraction unit.

### BACKGROUND

In stores such as a grocery, an operation is performed to reduce losses due to discardment, in particular by performing a price reduction based on the degree of freshness of merchandise. In a POS system, a price reduction process is performed by attaching a price reduction seal to individual merchandise items to notify a consumer of a price reduction. However, the attachment of the price reduction seal based on the degree of freshness of merchandise is a manual process that creates a heavy burden on the workforce.

### DESCRIPTION OF THE DRAWINGS

FIG. 1 is a diagram illustrating a configuration example of a POS system including a merchandise identification apparatus according to an embodiment.

FIG. 2 is a diagram illustrating an example of a merchandise package having a freshness degree label according to an embodiment attached thereto.

FIG. 3 is a block diagram illustrating a configuration example of the merchandise identification apparatus according to the embodiment.

FIG. 4 is a diagram illustrating a first configuration example of the freshness degree label according to the embodiment.

FIG. 5 is a diagram illustrating a second configuration example of the freshness degree label according to the embodiment.

FIG. 6 is a flow chart illustrating an operation example of a scanner unit of the merchandise identification apparatus according to the embodiment.

FIG. 7 is a flow chart illustrating an operation example of a POS terminal of the merchandise identification apparatus according to the embodiment.

FIG. 8 is a diagram illustrating an example of PLU information which is registered in the POS terminal of the merchandise identification apparatus according to the embodiment.

FIG. 9 is a flow chart illustrating an example of a discount recognition process in a scanner unit of the merchandise identification apparatus according to the embodiment.

FIG. 10 is a diagram illustrating an example of an indicator table for the freshness degree label of the first configuration example.

FIG. 11 is a flow chart illustrating an example of an indicator table for the freshness degree label of the second configuration example.

FIG. 12 is a diagram illustrating a third configuration example of the freshness degree label according to the embodiment.

FIG. 13 is a diagram illustrating a fourth configuration example of the freshness degree label according to the embodiment.

FIG. 14 is a diagram illustrating a fifth configuration example of the freshness degree label according to the embodiment.

FIG. 15 is a diagram illustrating a first relationship example between a detection body and an indicator in the freshness degree label according to the embodiment.

FIG. 16 is a diagram illustrating a second relationship example between a detection body and an indicator in the freshness degree label according to the embodiment.

### DETAILED DESCRIPTION

Embodiments provide a merchandise identification apparatus, a method of recognizing a discount for merchandise, and a freshness degree label which are capable of comprehensibly presenting a price reduction of merchandise based on the degree of freshness without requiring manual work.

According to one embodiment, a merchandise identification apparatus includes an image acquisition unit, a first extraction unit, a second extraction unit, and a determination unit. The image acquisition unit acquires a merchandise image of a merchandise to be purchased. The first extraction unit extracts an image of a freshness degree label from the merchandise image acquired by the image acquisition unit. The second extraction unit extracts image information indicating a degree of freshness of the merchandise from the image of the freshness degree label extracted by the first extraction unit. The determination unit determines a discount to a purchase price of the merchandise according to the image information indicating the degree of freshness of the merchandise extracted by the second extraction unit.

Hereinafter, an embodiment will be described with reference to the accompanying drawings.

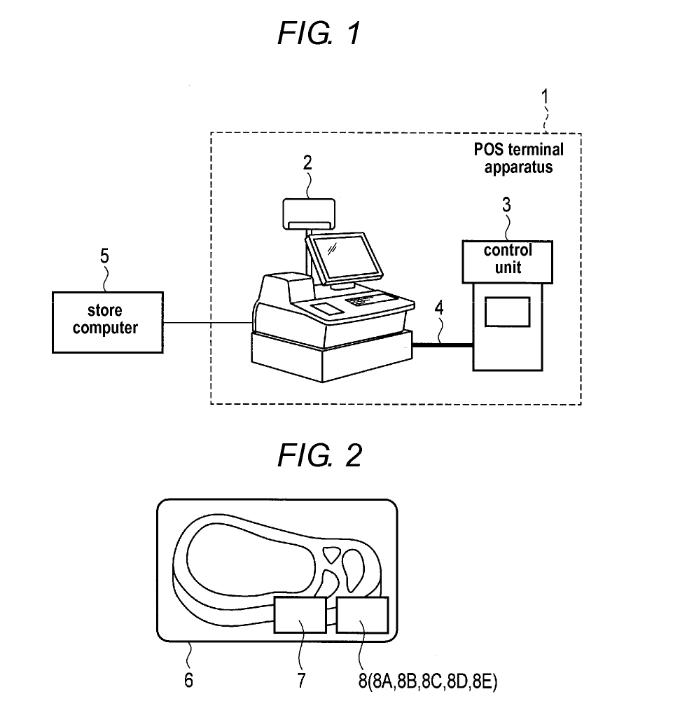

FIG. 1 is a diagram illustrating a configuration example of a POS terminal apparatus (merchandise identification apparatus) 1 according to an embodiment.

The POS terminal apparatus (merchandise identification apparatus) 1 includes a POS terminal 2 and a scanner unit (merchandise reader) 3 which are connected to each other through a communication line 4. The POS terminal 2 and the merchandise reader 3 may be devices which are formed as one integrated unit. In addition, the merchandise identification apparatus 1 is connected to a store computer 5. A POS system is a system in which the plurality of merchandise identification apparatuses 1 and the store computer 5 are connected to each other.

The POS terminal 2 registers merchandise and performs settlement for each transaction. The merchandise reader 3 reads information related to merchandise. The store computer is a host computer for the merchandise identification apparatus 1. The store computer 5 transmits and receives various pieces of data to and from the merchandise identification apparatus 1 in a store or a merchandise identification apparatus in another store. For example, the store computer 5 distributes a PLU file to the POS terminal 2.

FIG. 2 is an example of merchandise 6 to be processed by the POS terminal apparatus (merchandise identification apparatus) 1.

In the example illustrated in FIG. 2, a merchandise label 7 and a freshness degree label 8 are attached to the merchandise 6.

The merchandise 6 is packaged in a state where the merchandise label 7 and the freshness degree label 8 may be attached. The merchandise label 7 shows information related to merchandise. For example, the merchandise label 7 includes a bar code (information shown in the form that allows identification information of merchandise to be read by a scanner), a price, a merchandise name, and raw materials. The scanner unit 3 decodes the bar code in the merchandise label 7 to obtain the identification information (merchandise code) of the merchandise. The freshness degree label 8 shows information indicating the degree of freshness of the merchandise. The freshness degree label (price reduction label) 8 also shows a discount rate, a discount price, or the like of the merchandise based on the degree of freshness. For example, the scanner unit 3 recognizes the discount rate from the information indicating the degree of freshness of the freshness degree label 8. A configuration example of the freshness degree label 8 will be described later in detail.

Next, a configuration example of the merchandise identification apparatus 1 will be described.

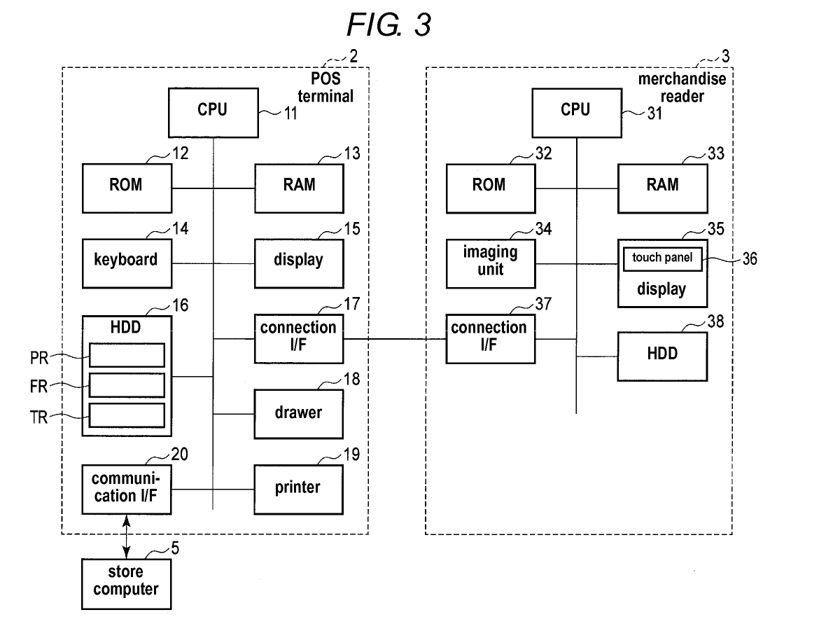

FIG. 3 is a block diagram illustrating the configuration example of the merchandise identification apparatus 1.

As illustrated in FIG. 3, the POS terminal 2 includes a central processing unit (CPU) 11, a read only memory (ROM) 12, a random access memory (RAM) 13, a keyboard 14, a display 15, a hard disc drive (HDD) 16, a connection interface (I/F) 17, a drawer 18, a printer 19, a communication interface (I/F) 20, and the like.

The CPU 11 controls the overall operation of the POS terminal 2. The CPU 11 is a processor that achieves various processes by executing a program. The CPU 11 is connected to units within the POS terminal 2 through a system bus or the like. The CPU 11 controls the keyboard 14, the display 15, the HDD 16, the connection interface 17, the drawer 18, the printer 19, the communication interface 20, and the like.

The ROM 12 is a non-rewritable nonvolatile memory that stores a program, control data, and the like. The RAM 13 is a volatile memory. The RAM 13 is a working memory or a buffer memory. The CPU 11 achieves various processes by executing a program and the like which are stored in the ROM 12 or the HDD 16 while using the RAM 13.

The keyboard 14 is an operation unit that receives an operation from a sales clerk. For example, the keyboard 14 includes a numeric keypad, a sub-total key, a total key, and the like. The display 15 is a display unit such as, for example, a liquid crystal display. Meanwhile, the keyboard 14 and the display 15 may be constituted by a display device with a touch panel attached, or the like. In addition, a display unit that presents information to a sales clerk and a display unit that presents information to a purchaser may be provided as the display 15.

The HDD 16 is a rewritable nonvolatile memory. The HDD 16 may be any of other rewritable nonvolatile memories such as an SSD. The HDD 16 has a region PR for storing a program, a region FR for storing a file such as a price look up (PLU) file, and a region TR for storing various data tables (an indicator table and the like). The program stored in the region PR is, for example, a program for achieving various operations of the POS terminal 2. The file stored in the region FR, for example, a PLU file which is distributed by the store computer 5 will be described later. The tables stored in the region TR are, for example, indicator tables Ta and Tb, which will be described later, and the like based on various freshness degree labels. In addition, process contents such as a settlement process may be saved as log information in the HDD 16.

The connection interface 17 is an interface for transmitting and receiving data to and from the merchandise reader 3. The connection interface 17 is connected to a connection interface 37 of the merchandise reader 3 through the communication line 4.

The drawer 18 is a cash holding unit. For example, the drawer 18 stores cash which is used in the merchandise identification apparatus 1.

The printer 19 is a printing unit that prints various pieces of data on a paper under the control of the CPU 11. For example, the printer 19 prints a receipt and the like. The printer 19 is not limited to a specific printing type and is, for example, an inkjet type or thermal transfer type printer.

The communication interface 20 is an interface for transmitting and receiving data to and from the store computer 5. The communication interface 20 may be an interface of a wireless or wired LAN. In addition, when the store computer 5 is located outside the store, the communication interface 20 may be an interface that transmits and receives data through a communications network such as the Internet.

Next, the merchandise reader 3 will be described.

As illustrated in FIG. 3, the merchandise reader 3 includes a central processing unit (CPU) 31, a read only memory (ROM) 32, a random access memory (RAM) 33, an imaging unit 34, a display 35, a touch panel 36, a connection interface (I/F) 37, an HDD 38, and the like. The merchandise reader 3 may include a rewritable nonvolatile memory that stores data such as a program, control data, and processing data. In addition, the merchandise reader 3 may include an auxiliary notification unit that notifies the reading of a specific merchandise. In addition, the merchandise reader 3 may include a keyboard for inputting information.

The CPU 31 controls the overall operation of the merchandise reader 3. The CPU 31 is a processor that achieves various processes by executing a program. The CPU 31 is connected to units within the merchandise reader 3 through a system bus or the like. The CPU 31 controls the imaging unit 34, the display 35, the touch panel 36, the connection interface 37, the HDD 38, and the like.

The ROM 32 is a non-rewritable nonvolatile memory that stores a program, control data, and the like. The RAM 33 is a volatile memory. The RAM 33 is a working memory or a buffer memory. For example, the RAM 33 saves frame images (captured images) which are sequentially imaged by the imaging unit 34. The CPU 31 achieves various processes by executing a program and the like which are stored in the ROM 32 or the nonvolatile memory while using the RAM 33.

The imaging unit 34 is an imaging unit that images an image of merchandise. The imaging unit 34 is installed at the back of a read window. For example, the imaging unit 34 is a camera with a color charge coupled device (CCD) and the like. The imaging unit 34 sequentially transmits captured images (frame images) of merchandise to the CPU 31.

The display 35 is a display unit that presents various pieces of information. For example, the display 35 is a liquid crystal display. In addition, the touch panel 36 is an operation unit that inputs various operations. It is assumed that the display 35 and the touch panel 36 are formed as one integrated unit. The touch panel 36 is provided on a display screen of the display 35.

The connection interface 37 is an interface for communicating with the POS terminal 2. The CPU 31 transmits and receives data to and from the POS terminal 2 through the connection interface 37.

The HDD 38 is a rewritable nonvolatile memory. The HDD 38 may be any of other rewritable nonvolatile memories such as an SSD. The HDD 38 saves executed process contents as log information. For example, the HDD 38 stores an image of merchandise which is captured by the imaging unit 34, an image of a merchandise label which is extracted from the image of the merchandise, a recognition result of a merchandise mode, an image of a freshness degree label which is extracted from the image of the merchandise, a result of a discount recognition process for the freshness degree label, and the like. Meanwhile, information may be stored in the HDD 16 of the POS terminal 2 rather than in the HDD 38.

Next, the configuration example of the freshness degree label 8 will be described.

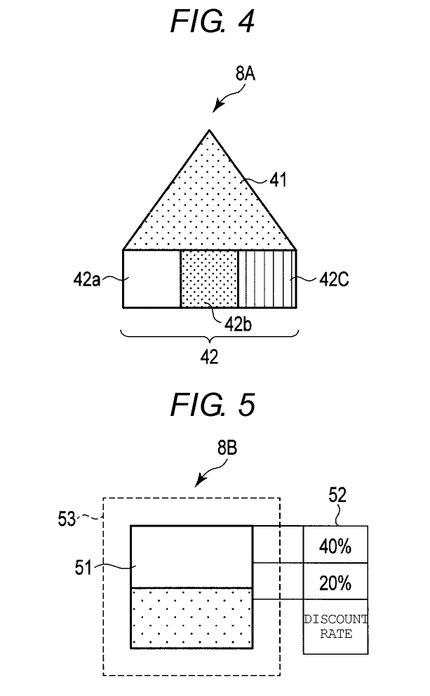

FIG. 4 is a diagram illustrating a first configuration example of a freshness degree label 8A. FIG. 5 is a diagram illustrating a second configuration example of a freshness degree label 8B.

The freshness degree label 8 according to this embodiment has a detection body of which the visible state changes with time or a decrease in the degree of freshness. A body having a state that changes by gas generated from merchandise is considered as the detection body. For example, the detection body detects the generation of any one or more of ethylene, carbon dioxide, ethyl acetate, butyl acetate, ammonium, and hypoxanthine, which results in a change in the state thereof. In addition, the detection body may be configured such that the color thereof changes, or may be configured such that the reaction area thereof changes (increases in size). In addition, the detection body may be configured such that the state thereof changes with time.

In addition, the freshness degree label 8 shows information indicating a discount based on the state of the detection body. The discount shown by the freshness degree label 8 may be a discount rate with respect to a sales price of merchandise or may be a discount amount. In addition, a point, a service, or the like may be given instead of the discount. In this embodiment, an example in which a discount rate is set based on the state of the detection body will be described.

FIG. 4 illustrates a configuration example of the freshness degree label 8A using a detection body of which the color changes.

The freshness degree label 8A illustrated in FIG. 4 has a detection body 41 and an indicator 42. The color of the detection body 41 changes with time or a decrease in the degree of freshness of merchandise. The indicator 42 has regions of a plurality of sample patterns 42a, 42b, and 42c. Each of the sample patterns 42a, 42b, and 42c indicates a discount rate based on the color of the detection body 41.

For example, the sample pattern 42a indicates the color of the detection body 41 having a discount rate of 0% (no discount). The sample pattern 42b indicates the color of the detection body 41 having a discount rate of 20%. In addition, the sample pattern 42c indicates the color of the detection body having a discount rate of 40%. The freshness degree label 8A illustrated in FIG. 4 shows a relationship between the color of the detection body 41 which indicates the degree of freshness of merchandise and a discount rate. A user may ascertain a discount rate of merchandise by comparing the color of the detection body 41 with the color of each of the sample patterns of the indicator 42 in the freshness degree label 8A attached to the merchandise.

As the detection body 41 of the freshness degree label 8A illustrated in FIG. 4, a detection body may be applied of which the color changes by gas (for example, ammonia) which is generated with time or a decrease in the degree of freshness. For example, food such as meat generates gas containing ammonia with the progress of rottenness due to germs. The degree of freshness of food such as meat may be indicated by the detection body 41 of which the color changes by ammonia. Therefore, the freshness degree label 8A using the detection body 41 of which the color changes by ammonia may be applied to the food such as meat.

Meanwhile, the freshness degree label 8A using the detection body of which the color changes by gas such as ammonia generated by merchandise such as food is attached to the package of the merchandise so that the detection body 41 may detect gas generated by the merchandise. For example, holes may be provided in the package of the merchandise having the freshness degree label 8A attached thereto so that gas generated from the merchandise reaches the portion of the detection body 41. In addition, the freshness degree label 8A may be attached to the inside of the package of the merchandise.

In addition, FIG. 5 illustrates a configuration example of the freshness degree label 8B using a detection body of which the reaction area changes.

The freshness degree label 8B illustrated in FIG. 5 includes a detection body 51, a discount display region 52, and a margin area 53. The reaction area of the detection body 51 changes with time or a decrease in the degree of freshness of merchandise. The discount display region 52 indicates a discount rate based on the reaction area of the detection body 51. The margin area 53 indicates a reference value in a read image of the freshness degree label 8B.

For example, it is assumed that the reaction area of the detection body 51 of the freshness degree label 8B illustrated in FIG. 5 expands from the lower side to the upper side with time or a decrease in the degree of freshness. In this case, discount display region 52 shows a discount rate that increases in stages based on the reaction area of the detection body 51.

For example, the detection body 51 of the freshness degree label 8B illustrated in FIG. 5 may be achieved by a detection body of which the reaction area changes according to the amount of detected ethylene gas. For example, food such as fruits and vegetables generates ethylene gas in association with respiration. For this reason, the degree of freshness of food such as fruits and vegetables may be indicated by a detection body of which the reaction area changes based on the amount of detected ethylene gas. Therefore, a freshness degree label using a detection body of which the reaction area changes by ethylene gas may be applied to food such as fruits and vegetables.

Meanwhile, the freshness degree label 8B using the detection body 51 of which the reaction area changes by gas such as ethylene gas generated from merchandise such as food is attached to the package of the merchandise so that the detection body 51 may detect gas generated from the merchandise. For example, holes may be provided in the package of the merchandise having the freshness degree label 8B attached thereto so that gas generated from the merchandise reaches the portion of the detection body 51. In addition, the freshness degree label 8B may be attached to the inside of the package of the merchandise.

In addition, the freshness degree label 8 may be a label using a detection body that indicates a common indicator, regardless of the type of merchandise, the state of the merchandise package, and the like. For example, a freshness degree label using a detection body of which the state changes with time may indicate a common indicator (elapsed time) regardless of the type of merchandise, the state of the merchandise package, and the like.

Next, an operation of the scanner unit 3 will be described.

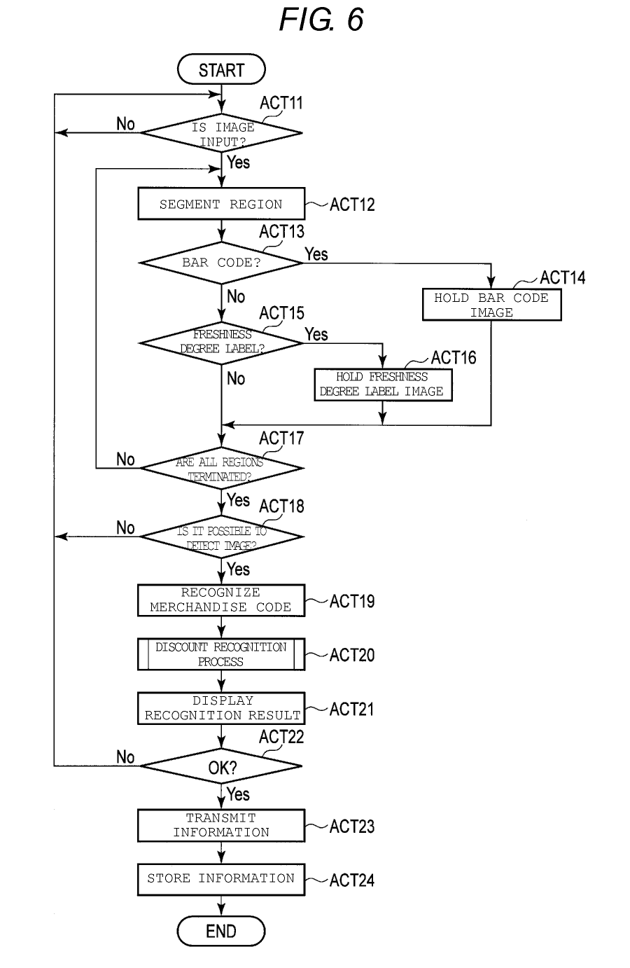

FIG. 6 is a flow chart illustrating an operation of the scanner unit 3.

When set in the standby state, the CPU 31 of the scanner unit 3 is in a state where a merchandise image may be read by the imaging unit 34 (ACT 11). When the merchandise 6 is presented to an imaging region of the imaging unit 34, the CPU 31 captures an image of the merchandise 6 through the imaging unit 34. A memory such as the RAM 33 for storing an image stores the image captured by the imaging unit 34. Meanwhile, the imaging unit 34 captures an image in which identification information of merchandise may be extracted from the merchandise label 7 and freshness degree information may be extracted from the freshness degree label 8. For example, herein, it is assumed that the imaging unit 34 captures a color image.

When a merchandise image captured by the imaging unit 34 is stored in memory (ACT 11, YES), the CPU 31 divides the merchandise image captured by the imaging unit 34 according to characteristic regions and segments the regions (ACT 12).

When the characteristic regions are segmented from the merchandise image, the CPU 31 chooses an image region of merchandise identification information (bar code) and an image region of a freshness degree label in a merchandise label from each of the segmented regions.

For example, the CPU 31 selects the image regions, which are segmented from the merchandise image, in order. When one of the segmented image regions is selected, the CPU 31 determines whether the selected image region is an image region of the bar code (ACT 13). When it is determined that the selected image region is the image region of the bar code (ACT 13, YES), the CPU 31 stores the selected image region as the image of the bar code in the RAM 33 or the HDD 38 (ACT 14).

In addition, when it is determined that the selected image region is not the image region of the bar code (ACT 13, NO), the CPU 31 determines whether the selected image region is the image region of the freshness degree label (ACT 15). When it is determined that the selected image region is the image region of the freshness degree label (ACT 15, YES), the CPU 31 stores the selected image region as the image of the freshness degree label in the RAM 33 or the HDD 38 (ACT 16).

When it is determined that the selected image region is neither the image region of the bar code nor the image region of the freshness degree label (ACT 15, NO), or when the selected image region is stored as the image of the bar code (ACT 14) or when the selected image region is stored as the image of the freshness degree label (ACT 16), the CPU 31 determines whether the determination process for all the image regions segmented from the merchandise image is terminated (ACT 17). When the determination process for all the image regions is not terminated (ACT 17, NO), the CPU 31 selects one image region from unselected image regions among the image regions segmented from the merchandise image and executes again the process of ACT 12 and the subsequent processes.

In addition, when the determination process for all the image regions is terminated (ACT 17, YES), the CPU 31 determines whether the image of the bar code and the image of the freshness degree label may be detected from the merchandise image (ACT 18).

When it is not possible to detect both the image of the bar code and the image of the freshness degree label cannot be detected (ACT 18, NO), the CPU 31 returns to ACT 11 to input the merchandise image again. For example, the CPU 31 displays a notice for prompting another presentation of the merchandise on the display 35 and images the merchandise again by the imaging unit 34.

When the image of the bar code and the image of the freshness degree label may be extracted (ACT 18, YES), the CPU 31 recognizes a merchandise code as identification information of the merchandise based on the image of the bar code which is stored in the RAM 33 (ACT 19). For example, the CPU 31 extracts the merchandise code by decoding the bar code. In addition, the CPU 31 performs a recognition process of recognizing a discount rate based on the image of the freshness degree label which is stored in the RAM (ACT 20). For example, the CPU 31 recognizes a discount rate from the state of the detection body of the freshness degree label based on a predetermined relationship between the state of the detection body of the freshness degree label and the discount rate. The recognition process of the discount rate will be described later in detail.

When the recognition process of the merchandise code and the recognition process of the discount rate are completed, the CPU 31 displays a recognition result on the display 35 (ACT 21). After the recognition result is displayed, the CPU 31 requires an operator to confirm the recognition result (ACT 22). For example, the CPU 31 displays the recognition result of the merchandise code, the recognition result of the discount rate, and an icon for prompting the approval or disapproval of the recognition result (OK button and NG icon) on the display 35. The operator confirms the recognition result displayed on the display 35, and touches the OK button by the touch panel 36 when it is determined that the recognition result is correct.

When the recognition results of the merchandise code and the discount rate are approved (ACT 22, YES), the CPU 31 fixes the merchandise code and the discount rate as the recognition results. When the merchandise code and the discount rate are fixed, the CPU 31 transmits information in which the merchandise code is associated with the discount rate, to the POS terminal 2 (ACT 23). In addition, the CPU 31 stores the read image of the merchandise, the image of the bar code, and the image of the freshness degree label together with the information in which the merchandise code is associated with the discount rate, as log information in the HDD 38 (ACT 24). Meanwhile, it is assumed that the information saved in the HDD 38 is saved for at least a predetermined period of time.

In addition, when the merchandise code and the discount rate as the recognition results are not approved (ACT 22, NO), the CPU 31 returns to ACT 11 to input the merchandise image again. For example, the CPU 31 displays a notice for prompting another presentation of the merchandise on the display 35 and images the merchandise by the imaging unit 34 again.

Meanwhile, when the recognition results are not approved, the CPU 31 may receive an operator's correction of the merchandise code or the discount rate as the recognition result. For example, the CPU 31 may display a notice screen receiving the correction of the merchandise code or the discount rate on the display 35 and may receive a change in the merchandise code or the discount rate by the touch panel 36.

Next, an operation of the POS terminal 2 will be described.

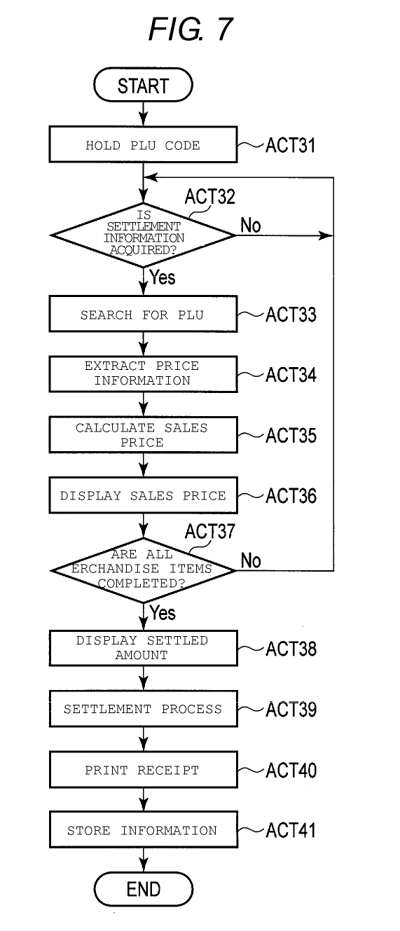

FIG. 7 is a flow chart illustrating an operation of the POS terminal 2.

The POS terminal 2 holds a PLU file in the HDD 16 (ACT 31). The CPU 11 of the POS terminal 2 downloads the PLU file from the store computer 5. The CPU 11 stores the PLU file downloaded from the store computer 5 in the HDD 16.

For example, as illustrated in FIG. 6, the PLU (price look up) is information in which a merchandise code is associated with a price thereof. The merchandise code is identification information for specifying merchandise. The merchandise code is shown by a bar code which is printed on the merchandise label 7 attached to the package of the merchandise. A sales price corresponding to the merchandise code is different for each store. The sales price is managed by the store computer 5 for each store. A PLU file having a merchandise code and sales price information as a set is stored in the HDD 16 of the POS terminal 2.

The POS terminal 2 having the PLU file held in the HDD 16 receives a merchandise code and a discount rate from the scanner unit 3 and performs a settlement process. When the merchandise code and the discount rate are received from the scanner unit 3 (ACT 32, YES), the CPU 11 searches for a relevant merchandise code from the PLU file within the HDD 16 (ACT 33). When the merchandise code is detected from the PLU file within the HDD 16, the CPU 11 extracts price information of the merchandise code based on the PLU (ACT 34). When the price information of the merchandise code acquired from the scanner unit 3 is extracted, the CPU 11 calculates an actual sales price based on the discount rate acquired from the scanner unit 3 (ACT 35).

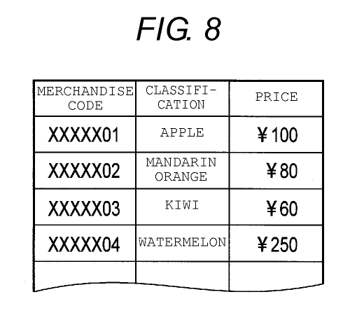

For example, according to a PLU illustrated in FIG. 8, a sales price of a merchandise code being an apple is “¥100”. In this case, when a discount rate is “20%”, calculation of “sales price=price×discount rate=¥100×(1−0.2)=¥80” is performed.

When the sales price is calculated, the CPU 11 stores the calculated sales price in the RAM 13 and displays the calculated sales price on the display 15 (ACT 36). The CPU 11 may display information such as a discount rate or a merchandise code together with the sales price on the display 35. In addition, the CPU 11 stores the sales price of the merchandise and also stores an amount of money obtained by accumulating sales prices of merchandise items for one user (total settled amount of money) in the RAM 13.

Whenever a process for one merchandise code is terminated, the CPU 11 determines whether processes (a calculation process of a sales price, and the like) for all the merchandise items of one user are completed (ACT 37). When it is determined that the processes for all the merchandise items are not completed (ACT 37, NO), the CPU 11 returns to ACT 32 to perform a process of acquiring information related to the subsequent merchandise (a merchandise code and a discount rate) from the scanner unit 3.

In addition, when it is determined that the processes for all the merchandise items are completed (ACT 37, YES), the CPU 11 displays the total settled amount of money held in the RAM 13 on the display 35 (ACT 38). When the total settled amount of money is displayed on the display 35, the CPU 11 performs a settlement process on the displayed total settled amount of money (ACT 39). For example, an operator inputs an amount of money received from a user. When the amount of money received from the user is input, the CPU 11 calculates change to be given to the user. The amount of money received from the user is received in the drawer 18, and the change to be given to the user is withdrawn from the drawer.

When the above-described settlement process is completed, the CPU 11 issues a receipt on which settlement contents (purchased merchandise, a purchase amount of money, and the like) are printed by the printer 19 (ACT 40). The operator gives the user the receipt printed by the printer 19 together with the change and terminates a series of settlement processes. In addition, when the settlement processes are completed, the CPU 31 stores information indicating settlement contents such as purchased merchandise, a purchase amount of money, and the like as log information in the HDD 38 (ACT 41). Meanwhile, when an image of a freshness degree label is acquired from the scanner unit 3, the CPU 31 may store the image of the freshness degree label as log information in the HDD 38.

Next, a discount recognition process of the scanner unit 3 will be described.

When a plurality of types are mixed in a freshness degree label, the CPU 31 of the scanner unit 3 specifies the type of freshness degree label and recognizes a discount (a discount rate or a discount amount) based on the specified type. When a freshness degree label of each type has a characteristic shape (in other words, when a type may be specified by a shape), the CPU 31 determines the type of freshness degree label by a pattern matching process for the shape of the freshness degree label. In addition, when each type of freshness degree label is specified, the CPU 31 of the scanner unit 3 calculates a discount rate according to the degree of freshness based on the format and the like of each type.

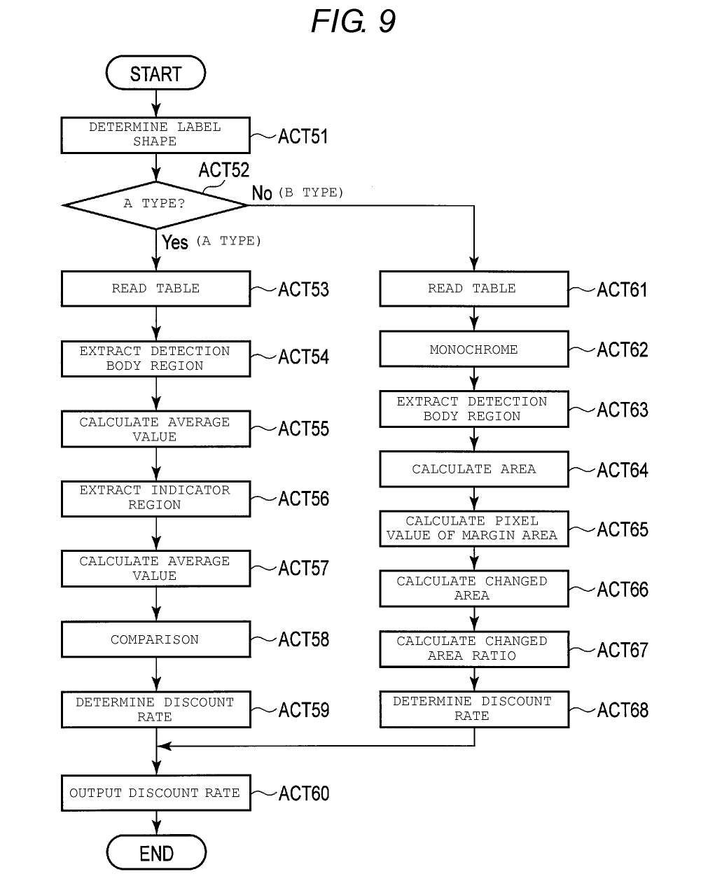

FIG. 9 is a flow chart illustrating a flow of a recognition process of a discount rate using a freshness degree label.

An operation example illustrated in FIG. 9 is an operation example which is made on the assumption that the freshness degree label 8A of the first configuration example illustrated in FIG. 3 is mixed with the freshness degree label 8B of the second configuration example illustrated in FIG. 4. In FIG. 9, the freshness degree label 8A of the first configuration example illustrated in FIG. 4 is referred to as an A type and the freshness degree label 8B of the second configuration example illustrated in FIG. 5 is referred to as a B type.

When a discount rate is recognized based on a freshness degree label, the CPU 31 performs a process of determining the type of freshness degree label based on an image of the freshness degree label (ACT 51). Herein, it is assumed that the freshness degree label includes an A type having a pentagonal shape and a B type having a quadrangular shape. Therefore, the CPU 31 determines whether a freshness degree label of a merchandise image captured by the imaging unit 34 is the A type having a pentagonal shape or the B type having a quadrangular shape, by a pattern matching process.

When it is determined that the freshness degree label is the A type (ACT 52, YES), the CPU 31 reads an indicator table for the freshness degree label 8A being the A type (ACT 53). The indicator table is stored in the HDD 16, for example.

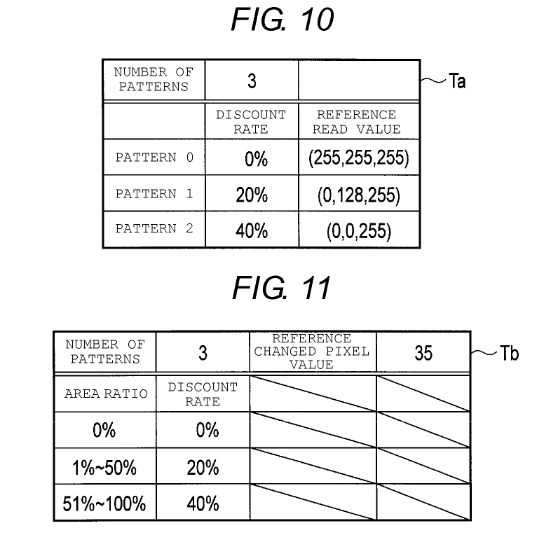

FIG. 10 illustrates an example of an indicator table Ta corresponding to the freshness degree label 8A being the A type which is illustrated in FIG. 4.

The example illustrated in FIG. 10 shows that there are three types of patterns of an indicator. In FIG. 10, it is assumed that a “first pattern” corresponds to the sample pattern 42a illustrated in FIG. 4, a “second pattern” corresponds to the sample pattern 42b illustrated in FIG. 4, and a “third pattern” corresponds to the sample pattern 42c illustrated in FIG. 4.

In the example illustrated in FIG. 10, the “first pattern” has a discount rate of 0%, and a reference pixel value (color pixel value of RGB) is “(R, G, B)=(255, 255, 255)”. The “second pattern” has a discount rate of 20%, and a reference pixel value (color pixel value of RGB) is “(R, G, B)=(0, 128, 255)”. The “third pattern” has a discount rate of 40%, and a reference pixel value (color pixel value of RGB) is “(R, G, B)=(0, 0, 255)”.

When the indicator table Ta for the A type is read, the CPU 31 extracts a region of the detection body 41 from the entire image of the freshness degree label (ACT 54). For example, the CPU 31 performs a pattern matching process using the shape of the region of the detection body in a reference format of the freshness degree label being the A type to extract the region of the detection body from the image of the freshness degree label. When the region of the detection body in the image of the freshness degree label is extracted, the CPU 31 calculates an average value of each pixel in the extracted region of the detection body (ACT 55). This is a process of calculating information indicating the color of the entire region of the detection body.

In addition, the CPU 31 extracts regions of the sample patterns 42a, 42b, and 42c of the indicator 42 from the entire image of the freshness degree label (ACT 56). For example, the CPU 31 extracts the regions of the sample patterns 42a, 42b, and 42c of the indicator 42 from the image of the freshness degree label based on the reference format of the freshness degree label being the A type. When the regions of the sample patterns 42a, 42b, and 42c of the indicator 42 are extracted from the image of the freshness degree label, the CPU 31 calculates an average value of each pixel in the extracted regions of the sample patterns 42a, 42b, and 42c (ACT 57).

When the average value of the region of the detection body 41 and the average values of the regions of the sample patterns 42a, 42b, and 42c are calculated, the CPU 31 determines the sample patterns 42a, 42b, and 42c of the indicator which is closest to the average value of the region of the detection body 41 to be patterns corresponding to the detection body 41 (ACT 58).

When the patterns corresponding to the detection body 41 are determined, the CPU 31 determines discount rates of the patterns corresponding to the detection body 41 in the indicator table Ta for the A type (ACT 59). When the discount rates are determined, the CPU 31 outputs the determined discount rates (ACT 60), and terminates the calculation process of the discount rate.

For example, it is assumed that an average value “(10, 100, 240)” of the region of the detection body 41, an average value “(245, 250, 252)” of the region of the sample pattern 42a, an average value “(25, 130, 245)” of the region of the sample pattern 42b, and an average value “(20, 32, 250)” of the region of the sample pattern 42c are obtained from the read image of the freshness degree label.

In this case, a difference between the average values of the detection body 41 and the sample pattern 42a is “|(10−245)|+|(100−250)|+|(240−252)|=397”, a difference between the average values of the detection body 41 and the sample pattern 42b is “|(10−25)|+|(100−130)|+|(240−245)|=50”, and a difference between the average values of the detection body 41 and the sample pattern 42c is “|(10−20)|+|(100−32)|+|(240−250)|=88”.

From the above-described calculation results, the average value of the region of the sample pattern 42b (equivalent to the second pattern of the table Ta) is closest to the average value of the region of the detection body 41 (difference is small). Therefore, the CPU 31 specifies that the detection body 41 is in a state of the sample pattern 42b, and determines the discount rate of “20%” corresponding to the second pattern which is equivalent to the sample pattern 42b, based on the indicator table Ta for the A type.

Meanwhile, since reading conditions fluctuate in an actual reading process using the imaging unit 34, read values of the sample patterns 42c, 42b, and 42c are generally different from a reference read value of the indicator table. This occurs because the read values fluctuate by reading conditions such as illumination conditions of a store, a manner of holding merchandise at the imaging unit 34, or stain on a label surface. In the freshness degree label 8A, the region of the detection body 41 and the regions of the sample patterns 42c, 42b, and 42c are disposed in areas adjacent to each other. For this reason, the CPU 31 compares the average value of the region of the detection body 41 in an actual read image with the average values of the regions of the sample patterns 42c, 42b, and 42c in the actual read image rather than with the reference read value of the indicator table Ta, and thus it is possible to perform a process with a reduced influence of the fluctuation by the reading conditions.

In addition, when the label surface is stained or when a manner of reading an image is inappropriate, the read values of the regions of the sample patterns in the read image may be greatly different from a reference read value of each pattern which is stored in the indicator table Ta. When the pixel value of the read image is greatly different from the reference read value (when it may be determined that the pixel value of the read image is abnormal), the CPU 31 may determine that it is not possible to use the read image in the calculation of a discount rate. When it is determined that it is not possible to use the image in the calculation of a discount rate, the CPU 31 prompts the rescanning of the merchandise. Thus, it is possible to achieve a reliable calculation of the discount rate.

In addition, when it is determined that the freshness degree label captured by the imaging unit 34 is the B type (ACT 52, NO), the CPU 31 reads the indicator table Tb for the freshness degree label 8B being the B type (ACT 53). For example, the indicator table Tb is stored in the HDD 16.

FIG. 11 illustrates an example of the indicator table Tb corresponding to the freshness degree label 8B being the B type which is illustrated in FIG. 5.

The example illustrated in FIG. 11 shows that there are three types of patterns in an indicator. In FIG. 11, a reference pixel value of a region reacting in the detection body 51 is “35”. In the example illustrated in FIG. 11, three patterns have a discount rate of 0% in a case of an area ratio being 0%, have a discount rate of 20% in a case of an area ratio being 1% to 50%, and have a discount rate of 40% in a case of an area ratio being 51% to 100%.

In addition, when it is determined that the freshness degree label is the B type, the CPU 31 converts an image of the freshness degree label 8B to a monochrome image (ACT 62). This is because color determination is not necessary with respect to the freshness degree label 8B. Thus, when the image of the freshness degree label 8B is converted to a monochrome image, the CPU 31 extracts the region of the detection body 51 by using a pattern matching process and the like based on a reference format of the freshness degree label 8B being the B type (ACT 63). When the region of the detection body 51 is extracted, the CPU 31 corrects the distortion of the image by affine transformation or the like and calculates an area of the region of the detection body 51 (ACT 64).

When the area of the region of the detection body 51 is calculated, the CPU 31 specifies the margin area 53 provided in the vicinity of the region of the detection body 51 and calculates a pixel value of the margin area (ACT 65). When the pixel value of the margin area is calculated, the CPU 31 performs a binarization process on the image of the region of the detection body 51 with reference to the pixel value of the margin area, and calculates an area of a region which has changed as a result of the reaction with the released gas from the merchandise (e.g., turned darker) in the region of the detection body 51 (changed area) (ACT 66). When the changed area of the region of the detection body 51 is calculated, the CPU 31 calculates a changed area ratio from the area of the region of the detection body 51 and the changed area (ACT 67). When the changed area ratio is calculated, the CPU 31 determines a discount rate corresponding to the changed area ratio with reference to the indicator table Tb for the B type (ACT 68). When the discount rate is determined, the CPU 31 outputs the determined discount rate (ACT 60) and terminates the calculation process of the discount rate.

For example, the CPU 31 rounds off the 1st decimal point of the calculated changed area ratio and determines a relevant discount rate in the indicator table Tb for the B type which is illustrated in FIG. 11. When the region of the detection body 51 is “(50,200)-(120,250)”, the number of pixels of the detection body 51 is “19500”, and a pixel value of the margin area 53 is “245”, if 100 is set as a margin from the value of the margin area 53, the CPU 31 counts a pixel having a pixel value being equal to or less than 145 as a changed pixel within the region of the detection body 51.

When the number of changed pixels in the region of the detection body 51 is “8055”, the CPU 31 calculates a changed area ratio to be “8055÷19500≈41%”. In this case, referring to the table Tb illustrated in FIG. 11, the CPU 31 determines that the changed area ratio of 41% is equivalent to a range of the discount rate of 20% (1% to 50%). Thus, the CPU 31 determines that the discount rate is 20%.

Meanwhile, in the example illustrated in FIG. 11, a relationship between the changed area ratio and the discount rate is as follows. An intermediate value of the discount rate is set to 20% and an upper limit is set to 40%. On the other rate is set to 20%, and when the changed area ratio is over 1% to be set to 51%, the discount rate is set to 40%. This hand, when the changed area ratio is set to even 1%, the discount is because a possibility is considered of a discount rate imaged by a user in comparison with an indicator being different from an actual discount rate due to the detection body 51 changing in an analog manner. In general, users rarely complain about a decrease in price, but complain about an increase in price. For this reason, a relationship between a memory of an indicator and a discount rate is designed in such a manner that the discount rate is likely to increase, thereby reducing the likelihood of the users' complaining. If a store sets a relationship between an indicator and a discount rate from the beginning on the premise of the above-described relationship, the store does not perform a discount more than necessary.

In addition, it is assumed that a read value of an actual read image of merchandise which is obtained by the imaging unit fluctuates by reading conditions such as illumination conditions of a store, a manner of holding merchandise at the imaging unit 34, or stain on a label surface. In other words, a read pixel value of a changed region of the detection body is generally different from a reference read value (theoretical value) of an indicator table. For this reason, the CPU 31 detects the changed region of the detection body 51 based on a read pixel value of the margin area 53 rather than based on the reference read value of the indicator table, with respect to an actual read image of the freshness degree label 8B. The CPU 31 may detect a changed region of the detection body 41 by reducing the influence of the fluctuation by the reading conditions based on the read pixel value of the margin area 53.

In addition, when the label surface is stained or when a manner of reading an image is inappropriate, the read value of the changed region of the detection body in the read image may be greatly different from a pixel value (reference value) of the changed region stored in the indicator table Tb, or the read pixel value of the margin area 53 may become an abnormal value. When it is determined that the read value is an abnormal value, the CPU 31 may determine that it is not possible to use the read image in the calculation of a discount rate. When it is determined that it is not possible to use the read image in the calculation of a discount rate, the CPU 31 prompts the rescanning of merchandise. Thus, it is possible to achieve a reliable calculation of the discount rate.

In this embodiment, a description is made of the discount recognition process of determining the type of freshness degree label based on the shape of the freshness degree label and switching a method of calculating a discount rate based on the determined type of freshness degree label. However, as an operating form, when there is a certain rule between merchandise and a freshness degree label to be attached to the merchandise, the discount recognition process may also be performed such that it is confirmed whether attachment failure occurs in the combination of the freshness degree label and the merchandise is confirmed by specifying merchandise from a merchandise code (bar code).

Next, a modified example of a freshness degree label will be described.

As described above, there is a detection body of a freshness degree label which shows analog (continuous) changes in association with a chemical reaction. Ina freshness degree label using the detection body showing analog changes, it is possible to minutely set a discount rate based on changes in the state of the detection body.

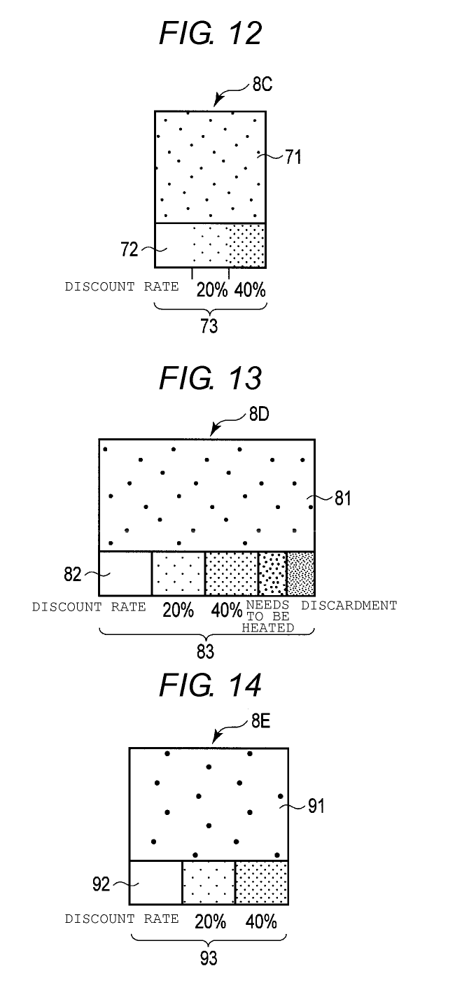

FIG. 12 is a diagram illustrating a third configuration example of a freshness degree label.

A freshness degree label 8C of the third configuration example illustrated in FIG. 12 has a region of a detection body, a region of an indicator, and a display region of a discount rate. A detection body 71 shows analog (continuous) changes based on changes in the degree of freshness. An indicator 72 shows continuous sample data for the changes in the detection body 71. A discount rate for the indicator 72 is displayed in a display region 73 for a discount rate.

For example, when the color of a detection body changes according to a change in the degree of freshness, the indicator 72 shows color that changes continuously (in a non-step manner) which is equivalent to the change in the color of the detection body. In the display region 73 of the discount rate, it is possible to minutely set a discount rate with respect to the change in the color of the indicator 72.

In addition, when a freshness degree label is used only for the purpose of showing a discount rate in a store, a detection body may show the degree of freshness in a range of a salable degree of freshness. However, the detection body may show the degree of freshness even in a range exceeding the salable degree of freshness. In other words, the detection body is considered to have an ability to show whether a sold merchandise item has a safe level of freshness to eat as it is, has a safe level of freshness to eat after being cooked, and the like. In the freshness degree label, the showing of the degree of freshness in a range exceeding a range of the salable degree of freshness by a detection body or an indicator includes the following advantages and disadvantages.

For example, a manager (store) has advantages such as “being able to view a level at which the merchandise has to be discarded due to an excess of an upper limit of a discount rate” and “being able to indirectly notify the selling of merchandise which is safe enough”, and a user (consumer) has an advantage of “having a material for determining an edible range after purchase (in a case of an intact package), and the like.

On the other hand, a user (consumer) taking safety for granted and coming to a store also has a disadvantage such as “possibility of hesitance to buy merchandise after viewing a freshness degree label assuming information for rottenness or discardment that the user does not want to view at the time of the purchase of the merchandise.

The above-described advantages and disadvantage are problems to be considered by a manager in accordance with business practices of a region where a store is located, store reliability, and a consumer's tendency. For this reason, a POS terminal apparatus is designed so as to be capable of dealing with any operation.

FIG. 13 is a diagram illustrating a fourth configuration example of a freshness degree label 8D. FIG. 14 is a diagram illustrating a fifth configuration example of a freshness degree label 8E. The freshness degree label 8D illustrated in FIG. 13 includes a detection body 81, an indicator 82, and a discount display region 83. The freshness degree label 8E illustrated in FIG. 14 includes a detection body 91, an indicator 92, and a discount display region 93.

FIG. 13 and FIG. 14 illustrate examples of two types of freshness degree labels having different configurations of indicators. The freshness degree label 8D illustrated in FIG. 13 shows not only a discount rate but also a notice of a change in the state of the detection body in a region exceeding an upper limit of the discount rate in the indicator. On the other hand, the freshness degree label illustrated in FIG. 14 illustrates only the state of the detection body corresponding to the discount rate in the indicator.

Therefore, a manager may select a certain type of freshness degree label in accordance with business practices of a region, store reliability, and a consumer's tendency by designing a POS terminal apparatus so as to be capable of dealing with either the type illustrated in FIG. 13 or the type illustrated in FIG. 14.

In a case of a detection body showing the degree of freshness by a change in color, a change occurs consistently according to the amount of gas detected and the like. However, it is not guaranteed that a change in the color of the detection body is a linear change to a human. For this reason, when the purpose is to view the amount of gas generated (the degree of freshness), an observer is required to read the indicator according to the change. However, the freshness degree label according to this embodiment is configured so as to accurately present price reduction information based on the degree of freshness to a user.

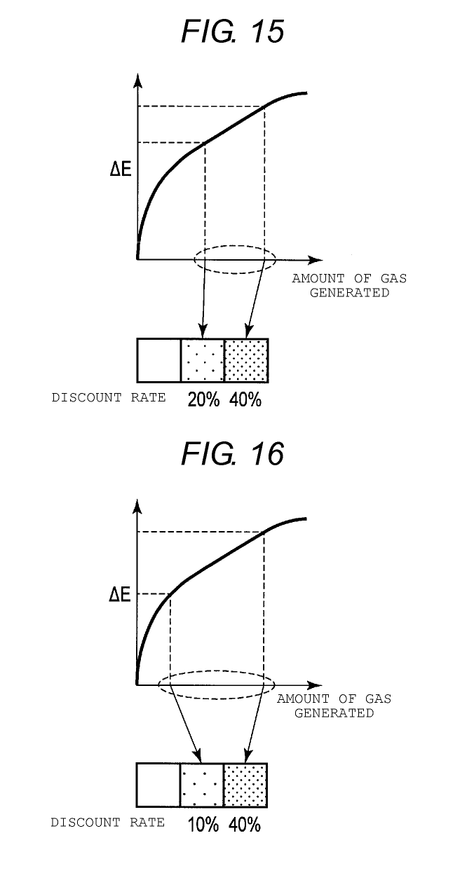

FIG. 15 illustrates a first setting example of an indicator with respect to the amount of change in a detection body. In addition, FIG. 16 illustrates a second setting example of an indicator with respect to the amount of change in a detection body.

For example, the detection body having characteristics illustrated in FIG. 15 illustrates a non-linear change when setting a vertical axis to the amount of change in the detection body (ΔE). For this reason, simply using the color of the vertical axis as an indicator in a manner corresponding to a uniform pitch with respect to a horizontal axis is considered to make it hard to read the difference thereof with human's eyes. On the other hand, as illustrated in FIG. 16, showing the indicator so that the change in the detection body (vertical axis) becomes uniform facilitates a user's viewing. In addition, information such as a discount rate may be set in accordance with the indicator. That is, the color of the indicator is correlated with the discount rate in a uniform color space, and thus it is possible to provide a freshness degree label that may be easily understood by a consumer.

Meanwhile, in the examples illustrated in FIG. 15 and FIG. 16, although the discount rate is changed from 20% to 10% in association with the amount of gas generated, the setting of the discount rate through the freshness degree label is determined by a manager in accordance with balance such as interests of a store and understandability of the discount rate. For example, in the example illustrated in FIG. 16, the setting to 10% may be changed to the setting to 20%. In this manner, in an actual operation, even though interests of a store are decreased due to an individual merchandise item, a discount rate (for example, 20%) which easily appeals to users may be provided. Meanwhile, even in this case, since patch expression of the indicator shown to a consumer is set based on a uniform color space which may be easily discriminated, the consumer convenience is not impaired.

In addition, when a relationship between a pixel value and a discount rate of a read image is linear, it is possible to determine a region of the corresponding indicator and a discount rate by a simple difference. On the other hand, when a linear relationship is not established between the pixel value and the discount rate of the read image, the pixel value of the read image is converted to a uniform color space, and thus it is possible to obtain the region of the corresponding indicator and the discount rate. For example, in the example illustrated in FIG. 16, the difference is calculated by converting an image signal value to the uniform color space, and thus it is possible to calculate the region of the corresponding indicator and the discount rate.

In the freshness degree label according to this embodiment, information to be displayed changes constantly with time or in response to changes in an environment even after a settlement process. For this reason, after the settlement process, a possibility is considered which a user (consumer), claims that a low discount rate is applied. In order to deal with such a situation, a scanner unit, a POS terminal, or a store computer may hold at least a read image of a freshness degree label which is imaged by the scanner unit 3 as log information for a certain period of time. According to such a configuration, after the settlement process, it is possible to reliably confirm the state of the freshness degree label during the settlement process.

Meanwhile, the recognition process of the freshness degree label which is described in this embodiment is not limited to the process in the POS terminal apparatus, and may be achieved by an apparatus with a processor capable of executing a processing program for the image of the freshness degree label. For example, the recognition process of the freshness degree label (the recognition process of the degree of freshness or the discount rate) may be achieved by a portable terminal (including, for example, a smart phone, a mobile settlement terminal, and the like) which has a function of being capable of capturing a merchandise image including a freshness degree label.

In addition, a detection body adapted for a freshness degree label may be configured such that a visible change in state occurs based on the degree of freshness or with time, and is not limited to the above-described examples. In addition, a format of the freshness degree label is not limited to the above-described examples.

According to the freshness degree label of the above-described embodiment, a basis for a price reduction may be presented to a consumer, and it is not necessary to frequently perform a process of attaching a label such as a price reduction seal, and thus it is possible to minutely set a price reduction.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A merchandise identification apparatus comprising:
an image acquisition unit configured to acquire a merchandise image of a merchandise to be purchased;
a first extraction unit configured to extract an image of a freshness degree label from the merchandise image acquired by the image acquisition unit;
a second extraction unit configured to extract image information indicating a degree of freshness of the merchandise from the image of the freshness degree label extracted by the first extraction unit; and
a determination unit configured to determine a discount to a purchase price of the merchandise according to the image information indicating the degree of freshness of the merchandise extracted by the second extraction unit.

2. The apparatus according to claim 1, wherein
the image information indicating the degree of freshness of the merchandise is information indicating a change in color of a detection region in the image of the freshness degree label extracted by the first extraction unit.

3. The apparatus according to claim 1, wherein
the image information indicating the degree of freshness of the merchandise is information indicating a change in size of a reaction area of a detection region in the image of the freshness degree label extracted by the first extraction unit.

4. The apparatus according to claim 1, further comprising:
a third extraction unit configured to extract image information of a discount indicator region from the image of the freshness degree label extracted by the first extraction unit,
wherein the determination unit is configured to determine the discount to the purchase price of the merchandise by comparing the image information indicating the degree of freshness of the merchandise with the image information of the discount indicator region.

5. The apparatus according to claim 1, further comprising:
a determination unit configured to determine a type of freshness degree label based on the image of the freshness degree label extracted by the first extraction unit,
wherein the second extraction unit is configured to extract the image information indicating the degree of freshness of the merchandise from the image of the freshness degree label in accordance with the determined type of freshness degree label.

6. The apparatus according to claim 1, further comprising:
a storage unit configured to store discount information for different merchandise according to degrees of freshness,
wherein the determination unit is configured to determine the discount to the purchase price of the merchandise according to the image information indicating the degree of freshness of the merchandise based on the discount information stored in the storage unit.

7. The apparatus according to claim 1, further comprising:
a non-volatile storage unit configured to store the image of the freshness degree label extracted by the first extraction unit.

8. A method of recognizing a discount for merchandise, the method comprising:
acquiring a merchandise image of a merchandise to the purchased;
extracting an image of a freshness degree label from the acquired merchandise image;
extracting image information indicating a degree of freshness of the merchandise from the extracted image of the freshness degree label; and
determining a discount to a purchase price of the merchandise according to the extracted image information indicating the degree of freshness of the merchandise.

9. The method according to claim 8, wherein
the image information indicating the degree of freshness of the merchandise is information indicating a change in the color of a detection region in the extracted image of the freshness degree label.

10. The method according to claim 8, wherein
the image information indicating the degree of freshness of the merchandise is information indicating a change in size of a reaction area of a detection region in the extracted image of the freshness degree label.

11. The method according to claim 8, further comprising:
extracting image information of a discount indicator region from the extracted image of the freshness degree label,
wherein the discount to the purchase price of the merchandise is determined by comparing the image information indicating the degree of freshness of the merchandise with the image information of the discount indicator region.

12. The method according to claim 8, further comprising:
determining a type of freshness degree label based on the extracted image of the freshness degree label,
wherein the image information indicating the degree of freshness of the merchandise is extracted from the extracted image of the freshness degree label in accordance with the determined type of freshness degree label.

13. The method according to claim 8, wherein
the discount to the purchase price of the merchandise is determined based on discount information for different merchandise stored in a storage unit according to degrees of freshness.

14. The method according to claim 8, further comprising:
storing the extracted image of the freshness degree label in a non-volatile storage unit.

15. A freshness degree label attached to a merchandise, the freshness degree label comprising:
a detection body having a state that changes in accordance with the degree of freshness of the merchandise; and
a discount display region that displays a discount according to different states of the detection body.

16. The label according to claim 15, wherein
a color of the detection body changes according to the degree of freshness of the merchandise.

17. The label according to claim 15, wherein
a size of a reaction area of the detection body changes according to the degree of freshness of the merchandise.

18. The label according to claim 15, wherein
the state of the detection body changes according to gas generated from the merchandise.

19. The label according to claim 15, further comprising:
a comparison target using which the change in the state of the detection body is detected,
wherein the discount display region displays discounts in correlation with different regions of the comparison target.

20. The label according to claim 15,
wherein the discount display region further displays other states of the merchandise that are correlated with degrees of freshness of the merchandise that are below a minimum standard for sale.
